(19) United States
(12) Patent Application Publication
(10) Pub. No.: US 2004/0257994 A1
(43) Pub. Date: Dec. 23, 2004

(54) System and method for network communications management

(75) Inventors: Trevor J. Paskett, Layton, UT (US); Bryan C. Scott, Sandy, UT (US)

Correspondence Address: Steve M. Perry, THORPE NORTH & WESTERN, LLP, P.O. Box 1219, Sandy, UT, 84091-1219, US

(73) Assignee: Cymphonix Corporation

(21) Appl. No.: 10/870,170

(22) Filed: Jun. 17, 2004

Related U.S. Application Data
(60) Provisional application No. 60/479,260, filed on Jun. 17, 2003.

(51) Int. Cl. G06F 15/173; G01R 31/08; G08C 15/00; H04L 12/26; G06F 11/00; H04J 3/14; H04J 1/16; H04L 1/00

(52) U.S. Cl. 370/230; 709/238

(57) ABSTRACT

A system and method are provided for managing network traffic to and from network nodes on a localized computer network. The method includes the operation of receiving data streams to and from the network nodes on the localized computer network. A user associated with each of the data streams can also be identified. A further operation is selecting a user rule for the data streams associated with each identified user. The user rule defines bandwidth allocation among the users. An application class for each of the data streams can be identified. An additional operation is selecting an application class rule for the data streams associated with each application class. The application class rule defines bandwidth allocation among the application classes. Another operation is provisioning bandwidth to the data stream used for transporting network traffic based on a combination of the user rule and the application class rule.

This application claims the benefit of priority from U.S. Provisional Application No. 60/479,260, filed Jun. 17, 2003.

### FIELD OF THE INVENTION

The present invention relates generally to managing a communications network.

### BACKGROUND

The Internet has become a valuable network communications system. It allows people to send e-mail around the world in a matter of minutes, access websites, and download information from a nearly unlimited number of remote locations. The Internet includes a collection of hosting servers and clients that are connected in a networked manner. In addition to the servers and client computers, other significant components enable the Internet to function. Some of the components the Internet uses to transfer information include routers, gateways, switches, hubs and similar network devices.

One device of particular interest is a router. Routers can be considered specialized electronic devices that help send messages, information, and Internet packets to their destinations along thousands of pathways. Much of the work to get a message from one computer to another computer on a separate network is done by routers, because routers enable packets to flow between interconnected networks rather than just within localized networks. Routers receive packets from the one or more networks that they are connected to and then determine to which network the packets should be forwarded. For example, a router for a local network may receive a packet that should be kept within the network because it uses a local address. This same router will also receive packets that may need to be sent to the Internet because the packets have an Internet address.

One of the tools a router uses to decide where a packet should go is a configuration table. A configuration table is a collection of information, including:

Information on which connections lead to particular groups of addresses.

Priorities for connections to be used.

Rules for handling both routine and special cases of traffic.

A configuration table can be simple or extremely complex in the very large routers that handle the bulk of Internet messages.

Routers have at least two separate but related jobs. First, the router ensures that information is not sent to networks where the information is not needed. This protects the networks from one another, preventing the traffic on one network from unnecessarily spilling over to the other. Second, the router makes sure that the information it receives is passed on to its intended destination network.

In performing these two jobs, a router is useful for dealing with two or more separate computer networks. The router can join the two or more networks by passing information between the networks and, in some cases, perform translations of various protocols between the two networks. As the number of networks attached to each other grows, the configuration table for handling traffic among them grows and the processing power of the router is generally increased. Regardless of how many networks are attached to a router, the basic operation and function of the router remains the same. Since the Internet is one huge network made up of tens of thousands of smaller networks, routers connect these networks together.

Internet data in a message or file is broken up into packets about 1,500 bytes long. Each of these packets has a wrapper that includes information about the sender's address, the receiver's address, the packet's place in the entire message, and how the receiving computer can be sure that the packet arrived intact. Each data packet is sent to its destination via the best available route—a route that might be taken by all the other packets in the message or by none of the other packets in the message. The advantage of this scheme is that networks can balance the load across various pieces of equipment on a millisecond-by-millisecond basis. If there is a problem with one piece of equipment in the network while a message is being transferred, packets can be routed around the problem, ensuring the delivery of the entire message.

In addition to the addressing information, a packet includes a data portion that is the original information being transmitted. Data packets can be classified by the protocol used to send the information, the application being used to originate the information and the user or machine generating the network traffic, among many others. A data stream that is sent during a session is a plurality of data packets which convey the original message.

Hubs, switches and routers all take data from computers or networks and pass them along to other computers and networks, but a router is generally the device that examines each data packet as it passes and makes a decision about exactly where the data or packet should go. To make these decisions, routers must first know about network addresses and network structure.

Every piece of equipment that connects to a network has a physical address, regardless of whether the equipment is located on an office network or the Internet. This is an address that is unique to the piece of equipment that is actually attached to the network cable. For example, if a desktop computer has a network interface card (NIC) in it, the NIC has a physical address permanently stored in a special memory location. This physical address, which is also called the MAC address (Media Access Control), has two parts that are each 3 bytes long. The first 3 bytes identify the company that made the NIC. The second 3 bytes are the serial number of the NIC itself.

A computer can have several logical addresses at the same time. This enables the use of several addressing schemes, or protocols, from several different types of networks simultaneously. For example, one address may be part of the TCP/IP network protocol, and another may be for Novell's IPX/SPX protocol. The network software that helps a computer communicate with a network takes care of matching the MAC address to a logical address. The logical address is what the network uses to pass information along to a computer.

Routers are programmed to understand the most common network protocols. That means they know the format of the addresses, how many bytes are in the basic package of data sent out over the network, and how to make sure all the packages reach their destination and get reassembled. In a packet-switched network, every message is broken up into small packets. The packets are sent individually and reassembled when received at their final destination. Depending on the time of day and day of the week, some parts of large packet-switched networks may be busier than others. When this happens, the routers that make up this system will communicate with one another so that traffic not destined for the crowded area can be sent by less congested network routes. This lets the network function at full capacity without excessively burdening already-busy areas.

There are many different protocols, each of which have various behaviors in a data network. One example is the HTTP (HyperText Transfer Protocol) which is used to send and receive data over the Internet and other networks. This protocol was originally designed to send and receive as much data as possible over any available network connection. This results in its ability to be used on slow “dial-up” connections as well as super-fast “broadband” network connections to the Internet, for example. It also makes it a greedy protocol because it will take any available bandwidth, to the point of causing congestion or contention among other applications or protocols that may also be using the network. Many other network protocols are designed this way due to the time period during which they were designed or the desire to capture as much bandwidth as possible for any given communication session.

### SUMMARY OF THE INVENTION

A system and method are provided for managing network traffic to and from network nodes on a localized computer network. The method includes the operation of receiving data streams to and from the network nodes on the localized computer network. A user associated with each of the data streams can also be identified. A further operation is applying a user rule for the data streams associated with each identified user. The user rule defines bandwidth allocation among the users. An application class for each of the data streams can be identified. An additional operation is applying an application class rule for the data streams associated with each application class. The application class rule defines bandwidth allocation among the application classes. Another operation is provisioning bandwidth to the data streams used for transporting network traffic based on a combination of the user rule and the application class rule.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a flow chart illustrating a method for managing network traffic to and from network nodes on a localized computer network in an embodiment of the invention;

FIG. 2 is a detailed flow chart illustrating an embodiment of a method for managing network traffic to and from network nodes with defined user rules and application class rules;

FIG. 3 is a flow chart illustrating an embodiment of a method for classifying network traffic received from network nodes on a localized computer network;

FIG. 4 is a block diagram illustrating an embodiment of a computer network using a management and bandwidth provisioning module;

FIG. 5 is a block diagram of a system for controlling and managing bandwidth on a computer network in accordance with an embodiment of the present invention; and

FIG. 6 depicts XML management data in an embodiment of the invention.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

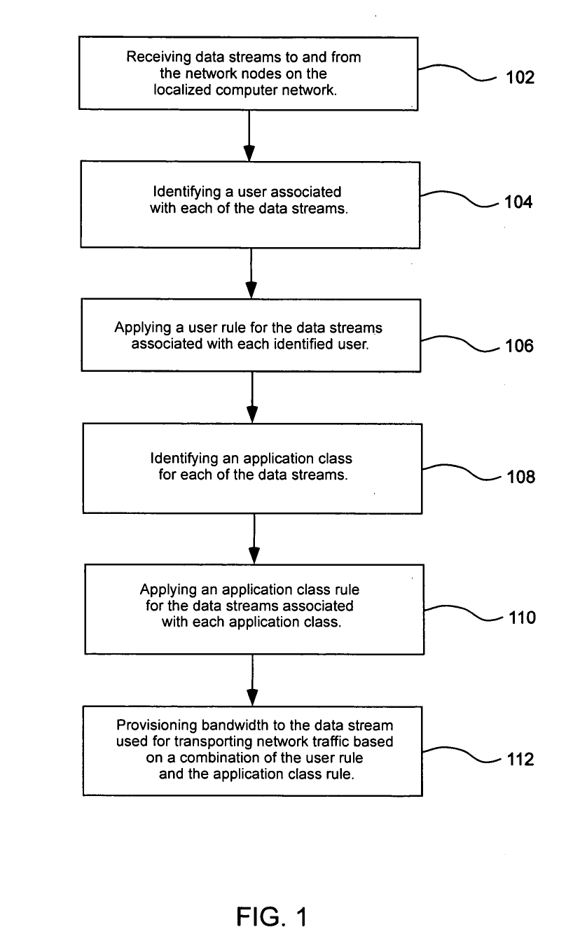

A system and method are provided for managing network traffic to and from network nodes on a localized computer network, as illustrated in FIG. 1. The method includes the operation of receiving data streams to and from the network nodes on the localized computer network, as in block 102. A data stream will be a generally continuous stream of packets or messages that is generated by a computer program when the program is communicating across the localized computer network. As mentioned previously, these communications may take place using TCP/IP, IPX/SPX, HTTP, FTP, TELNET and other communication protocols. A user associated with each of the data streams can also be identified, as in block 104. A user can be anything that has a network address, such as an end user who logs into a computer, a printer, a network attached storage or other similar devices.

A further operation is applying a user rule for the data streams associated with each identified user, as in block 106. The user rule defines bandwidth allocation among the users. An application class for each of the data streams can also be identified, as in block 108. An application class can be application types such as peer-to-peer applications, database applications, email, streaming audio or video applications, etc. The application class can be also be defined at a more granular level if desired. For example, the application class may define named applications such as Microsoft® SQL Server, RealAudio®, Music Match®, or other named applications.

An additional operation is applying an application class rule for the data streams associated with each application class, as in block 110. The application class rule can define bandwidth allocation among the application classes or between data streams within an application class. The contents of the user rules and application class rules will be discussed in further detail later. Another operation is provisioning bandwidth to the data stream used for transporting network traffic based on a combination of the user rule and the application class rule, as in block 112. The provisioning of the bandwidth is generally performed by taking into account the limitations of the user rule and/or the application class rule to arrive at a calculated amount of bandwidth that the data stream will be allowed to use to transmit its packets or data. Any data sent using a given data stream that exceeds the defined amount of bandwidth may be restricted or delayed until the data packets are able to be sent using just the amount of bandwidth allocated to the user and/or identified application.

In a default configuration of the present invention, the management system can determine how many users or applications are attempting to utilize a given network connection and can provide managed bandwidth access or even equal shares for the available bandwidth. For example, if five users are accessing the Internet using web browsing applications from their desktop computers, the system may provide all of the five users with the same amount of bandwidth, regardless of when they started their browsing sessions. In a different example, if two different types of applications or protocols (e.g., FTP download and HTTP) are in use, the system can still provide managed access to both applications even if one protocol is more greedy that the other.

When additional applications or users begin accessing the network connection, the bandwidth management system can continue to provide managed access to all users, regardless of application, protocol, user or the order in which they sought access to the system. Providing such structured access on a continuing basis can be performed by dynamically reallocating the bandwidth allocated as the data streams, applications and users change.

In another embodiment of the invention, certain types of network traffic may be classified by a system administrator or management personnel as more important or less important than other types of network traffic or data streams. For example, business critical or latency sensitive applications may need priority access to network resources. In addition, there may be other users who need priority bandwidth because of their job duties or applications they are using. At the other extreme, peer-to-peer downloading and online gaming traffic may not be important to network managers or even prohibited.

By prioritizing applications and protocols, using user rules, and using application rules, the bandwidth management system can then use these relative priorities and rules to determine which kinds of traffic and data streams are passed through immediately, which are delayed while more important traffic passes, and which data streams are denied passage entirely.

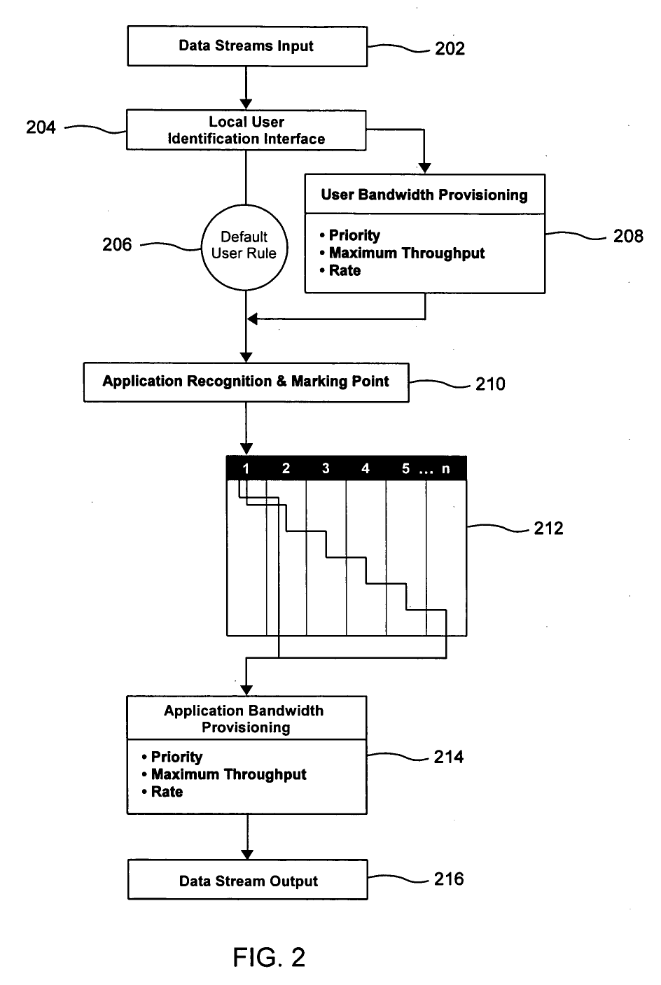

FIG. 2 illustrates a more detailed embodiment of the invention for managing network traffic to and from network nodes on a localized computer network. The present invention can be computer software loaded on a network management device such as a network router or server. Alternatively, the present invention can be stored in the firmware or ROM of a network management device. In the present invention, a data stream with data elements (e.g., packets) is received by the present system and is passed in or out of the network 202. These data streams or data elements are routed to a local user identification interface 204 to recognize and check the user status. The user status is determined by applying a current user rule that represents the user bandwidth provisioning or allocation. In the situation where there is no externally defined rule or policy for the user, the traffic can be returned to the normal system flow. As a result, the default rule 206 can then be applied which states that the user will equally share bandwidth with other users at the same (or lowest) priority level.

When a user rule exists for the user, the traffic is bandwidth provisioned or bandwidth controlled based on the user rule 208. The user rule may be as simple as a fixed amount of bandwidth allocated to a user or the rule can be derived from a complex calculation based on numerous factors. For example, the user rule may contain a priority for a user, an absolute maximum bandwidth for a user, or a user weighting that represents the relative weight of the user within the priority. When a user rule exists, the system uses this information to select various management methods, such as allowing the data stream to pass unimpeded, introducing a delay in the data stream, or blocking the data stream. Such actions can also be taken proportionately to the system flow as defined by the user rules.

The data streams with their data elements continue on to an application recognition and marking point 210. The application matching engine examines many different characteristics of the data elements to determine which application and/or protocol is represented. The matching characteristics are examined in an efficient way, so that once the application is recognized, it is returned to the system flow immediately without matching against additional unnecessary criteria. Chart 212 in FIG. 2 illustrates that efficient matching can identify the application in just one or two steps for many cases. In this process, the data element can be given a mark identifying the application class it belongs to. This mark may be carried through the entire system during the session the data stream exists.

Following application recognition, the application class rule 214 can be applied based on the application class the data stream belongs to. If there is no rule for the application class then a default application class rule will be assigned to the data stream. In a manner similar to the user rules, the default application class rule may equally share the provisioned bandwidth between applications with the same priority. When there is a rule for the application class, the traffic is apportioned based on the application class rule. The application class rule may be a simple bandwidth provisioning rule or a more complex definition based on the application type and needs of the bandwidth provisioning system. The application class rule may contain a priority for an application class, an absolute maximum bandwidth for an application class, a global application class weighting, a relative weight of the application within the priority, or other bandwidth management rules.

The data streams and data elements are then forwarded through the system to the bandwidth provisioning process or hardware (not shown) prior to exiting the system 216. The application class rules can be used independently to manage the bandwidth provisioned to the current data streams. Alternatively, the user rules and application class rules can be considered in combination to determine how to provision the system's total network communication bandwidth. As described for the user rule, the bandwidth provisioning can manage the data streams and allow the data stream to pass unimpeded, introduce a delay in the data stream, or entirely block the data stream.

Throughout the system of the present invention, information on users and applications is collected to provide many other services which include, but are not limited to, real-time monitors and historical reports displaying information about network traffic passing through or being mirrored to the system. For example, detailed reports can be generated for users, groups, or applications. These reports can quantify the use of the network bandwidth. In addition, diagnostic tools can be applied to extract information about network downtime and bandwidth allocation. Top bandwidth users can also be identified, and bandwidth hogs on the system can be isolated. Application type traffic use and patterns can also be more easily understood using the present invention. Application tracking can be applied by the day, hour, user, or application. The present system can also find out where users are going and restrict access if necessary.

Once the trends and trouble areas have been identified, system administrators and management personnel can prioritize and manage traffic to get the most of existing bandwidth. For example, the present system enables a network administrator to:

Distribute bandwidth more efficiently by allocating more bandwidth where needed.

Set priority by user, group, and application, as well as maximum and minimum throughput.

Protect bandwidth needed for core business applications.

Determine the amount of bandwidth used by individual or group, and charge appropriately for it.

When the system is configured to provision bandwidth using the user recognition service first, the user status settings/characteristics may be set as the limiting factor. However, this order can easily be changed by modifying the sequence of the services involved. Application restrictions can be examined first or be set as the limiting factor, if desired.

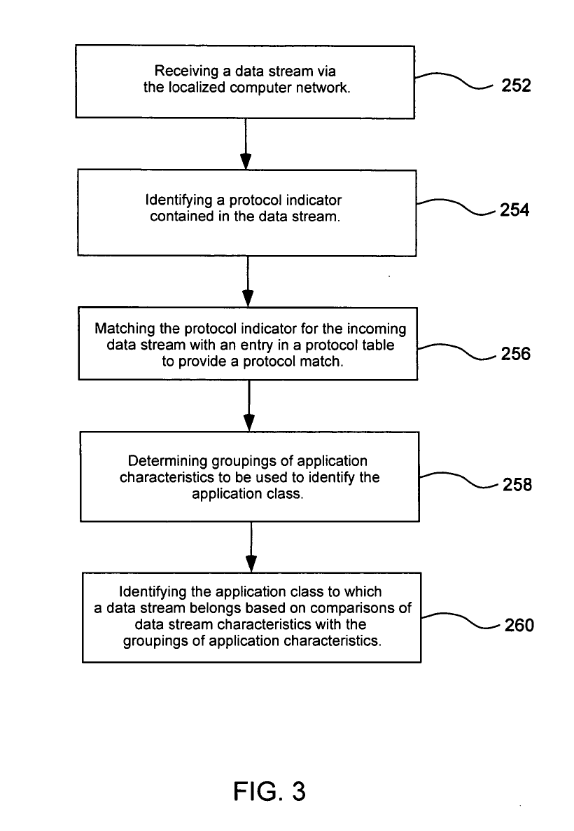

The present invention also classifies application types and data streams in an efficient manner as discussed previously. One embodiment of a method for classification includes the operation of receiving a data stream or data elements via the localized computer network, as in block 252 of FIG. 3. The data stream or data packets contain protocol indicators that are passed over public networks (such as the Internet). This protocol indicator is generally an opening piece of information in the recognition process. Another operation is identifying a protocol indicator contained in the data stream and data elements as in block 254.

Another operation is matching the protocol indicator for the incoming data stream with an entry in a protocol table to provide a protocol match as in block 256. This matching can be done at an individual packet level, port level or data stream level. The protocol match can indicate which additional characteristics can be used to identify the application. The identification system can then determine groupings of application characteristics to be used to identify the application class in response to the protocol match as in block 258.

The data element will be scheduled for further matching only against those characteristics potentially capable of providing additional or more granular information. This allows the system to maintain a high level of efficiency by not searching through characteristic tables unable to provide more information about the data element under examination.

Additional characteristic matches allow the data element to be more granularly defined and recognized. The following list provides examples of granular elements that can be checked, but should not be understood as a comprehensive listing of these potential characteristics. These elements can include: TCP, UDP, Port(s), TOS, custom characteristics, and regular expressions.

Once the groupings of application characteristics have been picked, then the application class to which a data stream belongs can be identified based on comparisons of data stream characteristics with the groupings of application characteristics as in block 260. The matching sequence established by the original protocol identification may be modified as a result of later, more fundamental/granular matching against other characteristics of the data element.

As matches occur, the data element can be marked to identify the most granular application match. Upon completion of all scheduled potential matching tables, the data element is returned to the system data flow with the final application mark. Data elements representing each distinct communication flow (e.g. session) are processed for recognition.

Once sufficient application recognition is made, all further data elements resulting from the communication flow are marked before entering the recognition process and immediately returned to the system flow. Each element may be matched by the application protocol and the regular expressions the data element or data stream contains. Other characteristic matches occur as appropriate.

Determining the application class quickly and efficiently is important because excessively latency in the computer network can cause lost data, delayed audio or video, and other significant problems. Once the application class has been identified then the application class rule can be applied and the bandwidth provisioning can take place as defined by the application class rule.

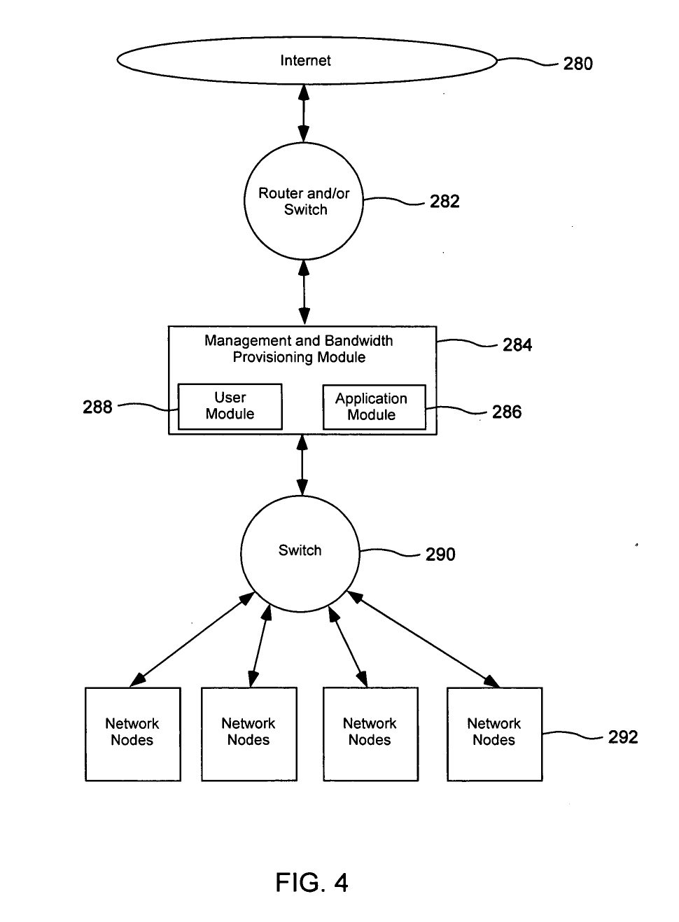

FIG. 4 is a block diagram illustrating a system for managing network traffic received from network nodes on a computer network. The system of the present invention includes a plurality of network nodes 292 having data streams and users. The network node can be connected to a local switch 290. In addition, network traffic can also be received from the Internet 280 through a router and/or a switch 282.

A user identification module 288 can be configured to identify a user associated with a network node for each of the data streams originating from the network nodes. A user rule module in the user module can be included to apply at least one user rule to the data streams originating from the user. The user rule can define an amount of bandwidth to be allocated to combined data streams associated with the user.

An application identification module 286 can be included for identifying an application class for the data streams. An application rule module in the application module may be included to apply at least one application class rule to the data streams. The application class rule determines a total amount of bandwidth allocated to the application class. The system of the present invention further includes a management and bandwidth provisioning module or unit 284 configured to provision bandwidth allocated to the data streams based on the combination of the user rule and/or the application class rule. The management and bandwidth provisioning module can be configured to be in communication with the network switches 290 and routers 282.

In another embodiment of the present invention, a central management database is provided that contains management data configured to regulate network bandwidth on a portion of the computer network. A management device is connected to the computer network and is in communication with the central management database. The management device is configured to control bandwidth for users attached to the management device. Management data for the specific portion of the network being controlled by the management device is downloaded into the management device from the central management database in order to enable the management device to control the bandwidth for end users and applications that are connected to at least one outside network through the management device.

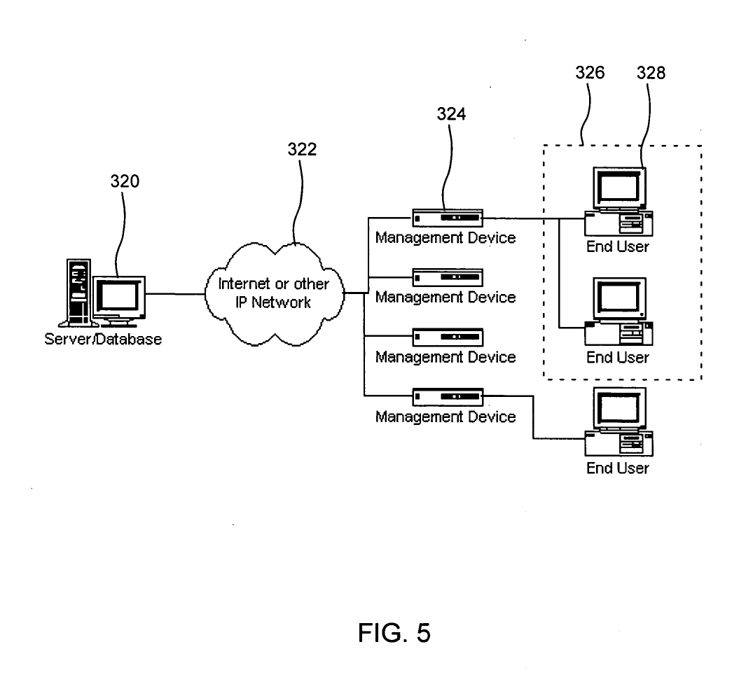

One embodiment of the invention provides a system and method for controlling and managing bandwidth on a localized computer network 326 as illustrated in FIG. 5. The term localized computer network is generally defined as a network that is separated from one or more other networks (e.g. the Internet). The system comprises a central management database 320 or server that contains management data configured to regulate network bandwidth on a portion of the localized computer network 326. A management device 324 is connected to the computer network and is in communication with the central management database via another network or the Internet 322. The management device is configured to control bandwidth for end users 328 or other computing devices attached to the management device. In addition, the management device can be a router or gateway that includes software to implement the functions described in this description.

Management data for the specific portion of the network 326 being bandwidth controlled by the management device is downloaded into the management device 324 from the central management database 320 in order to enable the management device to control the bandwidth for end users 328 that are connected to at least one outside network through the management device. The management data is dynamically transferred from the central management database at least once during a pre-determined period.

For example, one embodiment of the present system can use a central database that is downloaded to the management devices every 30 minutes or hour. The frequent downloads enable a user to be added to the network with a restricted bandwidth and then the user will be able to connect to the network through the management device within 30 minutes to one hour after they have been registered into the management database. In addition, this dynamic downloading provides one master database for a given network with multiple management devices. This helps overcome the need to track which management device a user connects to because the management database can be automatically distributed across all the management devices. This allows the end user to switch between management devices and no manual configuration needs to be done because each management device has the same database of all the end users.

One benefit of this system is that it allows end users to roam across a network. For example, if a user is connected to a wireless network with a laptop and the user moves between multiple buildings then the user is able to connect to multiple management devices and the bandwidth for that user can still be limited, controlled and managed. Bandwidth can also be managed and restricted based on a group of IP addresses or hardware addresses.

In an alternative embodiment, just a portion of the management data for a given segment of the network can be transferred to the management device based on the network segment for which the bandwidth is restricted. This means that if the management database is very large, just the appropriate portion of the bandwidth control data can be transferred to the network management device.

The use of network bandwidth is controlled at the management device. The traffic passes through the management device to the user. The bandwidth control is done based on the parameters in the management data. For example, an XML document can be used as the database format for the management data. The use of XML is beneficial because it is a modular data format and can be widely interpreted by a variety of management devices. If for some reason the management device cannot reach the server to download and update an XML data document, it will use the last downloaded data document until it is able to retrieve an updated data document. In server mode, the management device will download an XML document from the server. The server can be any database, text file, spreadsheet, or any other file that can store data.

The distribution of the management data can take place without the use of a central database server. In this embodiment, the management device has a local management database located with the management device. The centralized server can generate the XML document for the management device to use for controlling network bandwidth. Then this XML can be transferred to the management device via a network administrator initiated download or an email sent to the network administrator. In addition, a network administrator or manager can write a program to generate this XML document from a custom editor. Alternatively, the network administrator can use a text editor to edit the XML document. Then the management device will load the XML document into memory and restrict bandwidth based on this document. In a sense, a database server will be running locally.

In a standalone mode, the device may also use its own database to create the XML document. An extension of this is that the device can also act like a server for additional devices. This allows the customer to use pre-made databases, create their own management database, or use their own existing database of customer information that is edited into the appropriate format for management device to use.

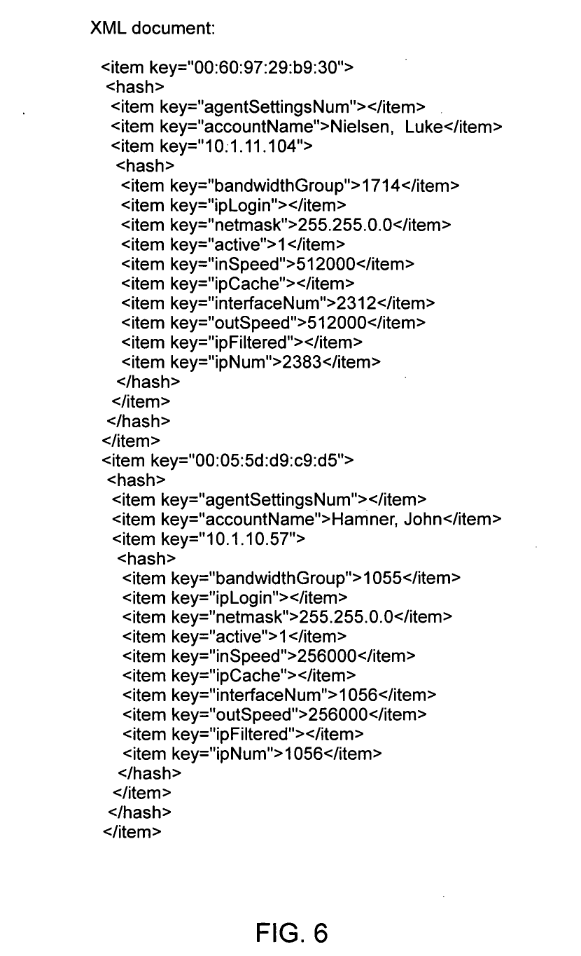

FIG. 6 illustrates a possible configuration for an XML file that can be used by a management device to restrict network bandwidth. The file as illustrated can define bandwidth settings such as whether the account is active, filtered, the amount of bandwidth a user is able to receive for a given time period. Another benefit of using an XML file to distribute information for controlling bandwidth using a management device is the economy of size. A compressed XML document that contains bandwidth restriction information for 4000 users can be just tens of kilobytes in size. A file of this comparatively small size takes just seconds to transfer over a modem. Thus, in a system where the management device is generally in a standalone mode, the database can be quickly downloaded to the management device using a low bandwidth connection.

XML may also be used to upload information to the server. Information such as bandwidth statistics, device uptime, total usage, and similar information can be uploaded every few minutes to every several hours depending on the setup configuration.

In conventional bandwidth restriction applications, the bandwidth allocation is distributed by contention. This method caps a user at a certain speed. If a user is set to 256K, then the user is not allowed to exceed the pre-set cap. However, if the management device or router's total possible bandwidth is exceeded by the users using the management device, the total bandwidth is divided between the users on a first come first serve basis. Unfortunately, this means that the device's total traffic can be divided in any random manner and there is no control.

For example if a user network has 1.5 Mb of bandwidth capability and 10 users are on the system actively downloading information, each user cannot exceed their individual 256 k bandwidth threshold. However, since there are 10 active users at 256 k each this is 2.5+Mb of traffic. Contention determines how much bandwidth each users gets. There is no guarantee that each user will get the same bandwidth and some may get none at all.

This present invention provides a bandwidth sharing that can distribute the available bandwidth among all the active users based on specific rules. Instead of using contention to determine who gets a certain amount of bandwidth, the bandwidth division can be calculated in real time to determine how much bandwidth to give each user. In the same example above with ten 256K users at 1.5 Mb, the software would check to see how many users are actively using the bandwidth and divide the bandwidth accordingly. For example, each user in this simple example can get 150 k of bandwidth evenly. This prevents one user from taking all the available bandwidth.

In another embodiment of the load balancing system, each user or group of users can be given a set priority. This enables the system to provide a weighted average load balancing between the users or a group of registered users. For example, a single router may serve a group of businesses in a building. However, each of these users may be paying for different amounts of bandwidth throughput. Dividing the bandwidth based on priority enables the Internet service provider to provide different levels of data services to each of these businesses in the building.

Many network and Internet-based bandwidth and security programs restrict the bandwidth of specific applications because they are known to be excessive bandwidth consumers. In fact, a firewall can completely block specific ports that are used on the Internet or World Wide Web (the Web). Internet applications generally communicate using a standard port. For example, HTTP and Web traffic use port 80. When a known port is used, it is easy to control an application's bandwidth by identifying the port number and simply restricting communication on the port. Unfortunately, newer applications like Peer-to-Peer file sharing programs can change ports at any time during the application's execution period. Such programs can even change ports if they detect they are being bandwidth-restricted on a specific port being used.

The present invention provides a system and method to overcome the problem of blocking and identifying packets for programs that dynamically change ports. In order to block a program that can dynamically change ports, a network management device is configured to perform bandwidth control and reporting based on certain identifying characteristics of a packet stream for an application. The management device or management router can create what can be describes as a signature. The signatures contain information like typical port numbers, common strings, packet sizes, dates, times, connection IDs, initiating ports, or similar signature data. For example, some applications send an ID string with a packet or group of packets, such as “x-napster” embedded in the packet. Any other unique packet identification can be used to identify packets for an application.

When the signature matching takes place, the management device or router can look at all the packets going through the device. If a packet matches an identifiable signature, then the management device will enable bandwidth control on that application or packet stream. The management device then watches all the remaining packets to determine if the packets belong to the connection used by the first packet. Typically, only the first packet will match a signature. The system can then enable reporting and bandwidth control on all these packets. This way the system can report and apply bandwidth control on almost any type of Internet traffic no matter what port is being used.

The management device can also be enabled to find the signature of applications that are not already known to the device. In doing this, the management device will first identify a new application that is consuming an excessive amount of bandwidth for a given time period. Then the management device will use the measuring tools it has to create a signature for the application. For example, the packet size can be measured or a repeating string can be captured to identify each packet for the new application. Then this signature can be used to restrict the bandwidth of the application. This method also provides the benefit that the bandwidth restriction cannot be hacked in real-time because the appropriate application signature has not been provided to the management device.

It is to be understood that the above-referenced arrangements and embodiments are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A method for managing network traffic moving to and from network nodes on a localized computer network, comprising the steps of:
receiving data streams to and from the network nodes on the localized computer network;
identifying a user associated with each of the data streams;
applying a user rule for the data streams associated with each identified user, wherein the user rule defines bandwidth allocation among the users;
identifying an application class for each of the data streams;
applying an application class rule for the data streams associated with each application class, wherein the application class rule defines bandwidth allocation among the application classes; and
provisioning bandwidth to the data streams used for transporting network traffic based on a combination of the user rule and the application class rule.

2. A method as in claim 1, wherein the step of provisioning bandwidth further comprises the step of provisioning bandwidth based on the lesser of the bandwidth defined by the user rule and the bandwidth defined by the application class rule.

3. A method as in claim 1, wherein the step of provisioning bandwidth further comprises the step of provisioning bandwidth based on the bandwidth defined by the application class rule as weighted by the bandwidth defined by the user rule.

4. A method as in claim 1, further comprising the step of introducing a delay in the data stream's traffic when the data stream's traffic exceeds a bandwidth restriction defined by the user rule.

5. A method as in claim 1, further comprising the step of introducing a delay in the data stream's traffic when the data stream's traffic exceeds a bandwidth restriction defined by the application class rule.

6. A method as in claim 1, further comprising the step of applying a user rule with a bandwidth allocation determined based on criteria selected from the group consisting of: a priority for a user, an absolute maximum bandwidth for a user, and a user weighting.

7. A method as in claim 1, wherein the step of provisioning bandwidth further comprises the step of performing actions on the data stream selected from the group consisting of: allowing the data stream to pass unimpeded, introducing a delay in the data stream, and blocking the data stream.

8. A method as in claim 1, further comprising the step of applying an application class rule with a bandwidth allocation determined based on criteria selected from the group consisting of: a priority for an application class, an absolute maximum bandwidth for an application class, and an application class weighting.

9. A method as in claim 1, wherein the user rule includes one or more default cases to be applied in the absence of specified criteria for the user.

10. A method as in claim 1, wherein the application class rule includes one or more default cases to be applied in the absence of specified criteria for the application class.

11. A method for managing application traffic to and from network nodes on a computer network, comprising the steps of:
receiving a plurality of data streams from the network nodes into an application recognition module;
identifying an application class for a data stream using identifying characteristics of the data stream;
determining a total amount of bandwidth allocated to the application class; and
provisioning bandwidth provided to the plurality of data streams in the application class based on the total amount of bandwidth allocated to the application class.

12. A method as in claim 11, further comprising the step of provisioning bandwidth used by each data stream belonging to the application class based on a ratio of the number of data streams currently active for the application class and total bandwidth allocated to the application class.

13. A method as in claim 12, further comprising the step of reallocating the amount of provisioned bandwidth used by each of the plurality of data streams within an application class when the number of data streams being used by network nodes on a computer network changes.

14. A method as in claim 13, further comprising the step of increasing bandwidth used by a data stream within an application class when the number of data streams being used by network nodes on a computer network decreases.

15. A method as in claim 13, further comprising the step of decreasing bandwidth used by a data stream within an application class when the number of data streams being used by network nodes on a computer network increases.

16. A method as in claim 12, further comprising the step of reallocating the amount of provisioned bandwidth used by each application class when the number of data streams being used by network nodes on a computer network changes.

17. A method as in claim 11, wherein the step of identifying an application class for a data stream further comprises the step of marking the data stream with an application class identifier for a remainder of a session for the data stream.

18. A method as in claim 11, wherein the step of provisioning bandwidth further comprises the step of applying an application class rule to perform a bandwidth management action on the data stream selected from the group consisting of: allowing the data stream to pass unimpeded, introducing a delay in the data stream, and blocking the data stream.

19. A method as in claim 11, wherein the step of identifying an application class for a data stream further comprises the steps of identifying the application class for a data stream using a matching engine.

20. A method as in claim 19, further comprising the step of using ordered matching criteria wherein the matching engine is configured to return the matching information to the system without matching against additional unnecessary criteria.

21. A method as in claim 19, further comprising the step of using the matching engine to determine the application type beginning with the application protocol being used for a data stream.

22. A method as in claim 19, further comprising the step of using regular expression matching in the matching engine to determine the application class for the data stream.

23. A system for managing network traffic to and from network nodes on a computer network, comprising:
a plurality of network nodes having data streams and users;
a user identification module configured to identify a user associated with a network node for each of the data streams originating from the network nodes;
a user rule module configured to apply at least one user rule to the data streams associated with the user, wherein the user rule defines an amount of bandwidth to be allocated to combined data streams associated with the user;
an application identification module configured for identifying an application class for the data streams;
an application rule module configured to apply at least one application class rule to the data streams, wherein the application class rule determines a total amount of bandwidth allocated to the application class; and
a bandwidth provisioning unit configured to provision bandwidth allocated to the data streams based on the combination of the user rule and the application class rule.

24. A system as in claim 23, further comprising a network switch configured to be in communication with the bandwidth provisioning unit.

25. A method of classifying network traffic to and from network nodes on a localized computer network, comprising the steps of:
receiving a data stream via the localized computer network;
identifying a protocol indicator contained in the data stream;
matching the protocol indicator for the incoming data stream with an entry in a protocol table to provide a protocol match;
determining groupings of application characteristics to be used to identify the application class in response to the protocol match; and
identifying the application class to which a data stream belongs based on comparisons of data stream characteristics with the groupings of application characteristics.

26. A method as in claim 25, further comprising the step of recording an application class for a data stream based on the comparisons between the data stream characteristics and the groupings of application characteristics.

27. A method as in claim 25, further comprising the step of marking the data stream with an application marker as a granular application match is made.
